(19) United States
(12) Patent Application Publication
(10) Pub. No.: US 2007/0203657 A1
(43) Pub. Date: Aug. 30, 2007

(54) Method And Device For Determining The Density And Speed Of Free-Flowing Media

(76) Inventors: Dieter Keese, Wahlsburg (DE); Thomas-Fritz Blume, Halle (Saale) (DE)

Correspondence Address: Michael M Rickin;Abb Inc, Legal Dept - 4u6, 29801 Euclid Avenue, Wickliffe, OH, 44092-1832, US

(21) Appl. No.: 11/630,920

(22) PCT Filed: Jun. 30, 2005
(86) PCT No.: PCT/EP05/07046

§ 371 Date: Dec. 27, 2006

(30) Foreign Application Priority Data
Jun. 30, 2004 (DE) 10 2004 031 641.4

(51) Int. Cl. G06F 19/00

(52) U.S. Cl. 702/45

(57) ABSTRACT

The invention relates to a method and a device for determining the density and speed of a free-flowing medium according to the preamble of patent claims 1 and 4. In order to obtain a larger variety of evaluation possibilities, the flow speed and/or the density p are derived from the cited sensory variables, according to the field equation F=G×B+p×E.

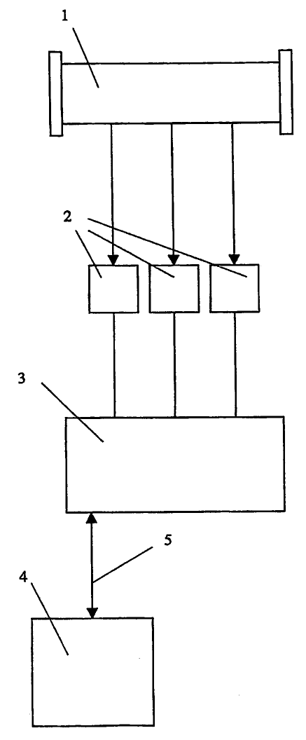

The invention relates to a method and a device for determining the density and speed of free-flowing media according to the preamble of claim 1.

Methods and devices of this type are known as flow meters, and they encompass a range of approaches for measuring flow speeds.

One known approach is to use a “vortex flow meter” for the measurement. In this case, a form of vibration is produced near a flow resistance by the vortices generated within the flowing medium at an additional flow element, for example a form of paddle, this vibration representing the volume flow rate or flow speed. This approach exploits the fact that at and above a certain flow value, the flow through such a measuring instrument is turbulent to a greater or lesser extent.

Other options for determining the flow rate are “inductive flow meters”, in which a magnetic field is used, and the effect of this magnetic field on a flowing medium is measured. Once again in this case there is a causal relationship between flow speed and the volume flowing through per unit of time.

Thus the invention is based on a measuring principle that can be used to measure the flow speed V and the density ρₘ of any electrically conducting medium in a closed pipeline system.

Here methods are thus known in the manner described in which the induction law is used as the basis for measuring the flow speed V, as in the inductive flow meter system for example. Flexural resonators etc. are generally used to determine the density.

So that the density and flow speed can be determined with the proposed principles, this measuring system can also be used to determine the mass flow rate of the media.

The flow speed and the density are measured using different principles here, however.

Thus the object of the invention is to determine both the flow speed and the density of the medium using one and the same device.

The specified object is achieved according to the invention, for a method of the generic type, by the characterizing features of claim 1.

Further advantageous embodiments of the method according to the invention are given in the dependent claims 2 to 3.

With regard to a device of the generic type, the specified object is given according to the invention by the characterizing features of claim 4.

Further advantageous embodiments of the devices according to the invention are given in the remaining claims.

The crux of the invention with regard to the method is that both the flow speed and the density are determined from the field equations. This is done in the following way.

Firstly the following physical variables are defined:

F=force

G=σ×E, current density

D=ξ×E, electric flux density

B=μ×H, magnetic induction

H=magnetic field strength

E=electric field strength

V=speed

ρ=resistivity

ρₘ=density

μ=permeability

ξ=dielectric constant

σ=conductivity

Thus in a manner according to the invention, the variables can be determined from the field equations:
F=G×B+ρE
and
B=μ×H, D=ξ×E and G=σ×E

The known physical effect exploited in measuring the flow speed is the induction law. Thus if an electrically conducting material to be measured is passed through a magnetic field B, an electric field E is produced in the material to be measured at right angles to the flow direction V and to the magnetic field direction.

Thus E=B×V. Now it follows in a manner according to the invention that there is also a relationship between the density ρₘ on the one hand and the material variables of resistivity ρ, permeability μ, dielectric constant ξ and conductivity σ on the other.

This can be expressed formally as ρₘ=f (ρ, μ, ξ, σ. By comparative measurements of the density ρₘ and known electrical material variables, a dependency array is then created, which can be used to determine the density. After determining the dependency array relating the density to the other material variables, not only the density but also the mass flow rate Qₘ can be calculated from the equation Qₘ=v×ρ. These additional calculations are computed inside the inductive flow meter (IFM) using electronic circuitry and the associated sensors, and formulated according to the embodiments of the invention as claimed in the dependent claims relating to the method. It is also proposed here to save the determined dependency array as a look-up table in an electronic analysis unit, so that it is possible to upgrade some existing devices working on the induction-method principle, i.e. IFM devices, to determine the density. This creates the option of upgrading in general, because the method according to the invention is made possible using existing devices with the addition of suitable electronic circuitry and/or implementing suitable software in the electronic circuitry.

For this reason, means are also provided with regard to the device that enable the implementation of the method according to the invention in the said IFM.

An exemplary embodiment and the main interdependencies of the individual components are shown in the drawing and described below.

The drawing first contains as the starting unit the measuring tube 1 of an inductive flow meter. This measuring tube 1 is surrounded by a magnet system, not shown in greater detail here, which generates the required magnetic field strengths that interact physically with the moving medium in the manner described.

A plurality of sensors 2 are shown schematically, which pick up the described sensory variables at the measuring tube 1, or rather in the magnetic system of the measuring tube. These sensory variables are recorded by the IFM analysis unit and taken account of and processed in the described manner according to the method. The variables derived from the sensory variables and calculated according to the formal dependencies in the manner described above are saved in a buffer memory 4 as a “look-up table”. These look-up tables then contain the said measurement variables in turn as a function of other recorded or determined variables in an addressed data array. This is connected via a bidirectional data-link 5 to the IFM analysis unit 3 again, so that the system can work in a self-updating and hence adaptive fashion. Learnt or calibrated data can hence be retrieved again, and thus not only current values can be determined, but also the progression i.e. history of a measured-value trend shown.

Graphs can be displayed from the values available in this way, from which one can implement either by analyzing the curves or else even by implicit electronic analysis, not only the displayed variables but also ageing effects and self-diagnosis options.

The buffer memory 4 can be implemented here in the electronic circuitry i.e. in the IFM analysis unit 3, as can the bidirectional data-link 5 as well. It is also possible, however, to add on this buffer memory and a bidirectional datalink 5 even at a later date, or to connect the IFM analysis unit 3 to such a buffer memory. Bus lines can be used to constitute the bidirectional data line.

1. A method for determining the density and speed of a free-flowing medium, in which sensory variables are recorded and processed,
characterized in that
the flow speed and/or the density ρₘ are derived from the said sensory variables according to the field equation F=G×B+Σ×E.

2. The method as claimed in claim 1,
characterized in that
the density is determined as a function of the resistivity ρ, permeability μ, dielectric constant ξ and conductivity σ.

3. The method as claimed in claim 1 or 2,
characterized in that
both the variables measured by the sensors and the derived variables are saved in an addressed data array, and both the current measurement situation and its history is recorded.

4. A device for determining the density and speed of a free-flowing medium, in which sensory variables are recorded and processed,
characterized in that
a plurality of direct physical variables are picked up by sensors (2) at the measuring system, and can be supplied to an analysis unit (3), which communicates with a data array (4) in buffer memory via a bi-directional data-line (5) in such a way that optionally both the current measurement situation with regard to directly measurable and also derived variables and their measured-value history can be displayed.

5. The device as claimed in claim 4,
characterized in that
the buffer memory 4 and bi-directional data-line 5 are arranged separately from the IFM analysis unit (3).

6. The device as claimed in claim 4,
characterized in that
the buffer memory 4 and the bi-directional data-line 5 are implemented inside the analysis unit 3.

7. The device as claimed in any of the preceding claims 4 to 6,
characterized in that
the method as claimed in any of claims 1 to 3 is designed as a software product, which can be downloaded at a data interface into the said device to carry out the method according to the invention.
